(19) United States
(12) Patent Application Publication
(10) Pub. No.: US 2024/0378406 A1
(43) Pub. Date: Nov. 14, 2024

(54) PRINTER GENERATING FONT DATA TO BE USED IN DRAWING PROCESS TO DRAW CHARACTER DESIGNATED IN PRINT DATA

(71) Applicant: BROTHER KOGYO KABUSHIKI KAISHA, Nagoya (JP)

(72) Inventors: Naoki HASHIMOTO, Nagoya (JP); Kenshiro NAKAJIMA, Kani (JP)

(21) Appl. No.: 18/659,555

(22) Filed: May 9, 2024

(30) Foreign Application Priority Data
May 9, 2023 (JP) 2023-077487

(51) Int. Cl. G06K 15/02

(52) U.S. Cl. CPC G06K 15/1827; G06K 15/1802

(57) ABSTRACT

A printer includes a memory, a print engine, and a controller. The controller performs an acquisition process to acquire print data. When the print data is of a second type different from a first type, the controller performs a generation process to generate a new set of font data in the second format based on the set of font data in the first format stored in the memory. The first type of print data supports a set of font data in a first format. The second type of print data support a set of font data in a second format different from the first format. When the generation process is performed, the controller performs a drawing process to draw an image of a character designated in the print data using the new set of font data generated in the generation process.

### REFERENCE TO RELATED APPLICATIONS

This application claims priority from Japanese Patent Application No. 2023-077487 filed on May 9, 2023. The entire content of the priority application is incorporated herein by reference.

### BACKGROUND ART

Some conventional printers perform printing on the basis of print data described in a page description language using font information stored on the printer in advance.

### SUMMARY

The format of font data can differ according to the type of print data. Therefore, users must prepare font data suitable for the type of print data and store this font data on the printer. However, requiring users to be mindful of the type of print data when preparing font data is not user-friendly.

In order to attain the above and other object, the present disclosure provides a printer. The printer includes a memory, a print engine, and a controller. The controller is configured to perform an acquisition process to acquire print data. When the print data is of a second type different from a first type, the controller is configured to perform a generation process to generate a new set of font data in the second format based on the set of font data in the first format stored in the memory. The first type of print data supports a set of font data in a first format. The second type of print data support a set of font data in a second format different from the first format. When the generation process is performed, the controller is configured to perform a drawing process to draw an image of a character designated in the print data using the new set of font data generated in the generation process.

The above technique can enable a printer to easily process print data regardless of a combination of a type of the print data and a format of font data being stored. Because the printer can process print data of any type, the user need not to consider the type of print data. Accordingly, the user-friendliness can be enhanced.

### BRIEF DESCRIPTION OF DRAWINGS

FIG. 1 is a block diagram illustrating an overview structure of a printer.

FIG. 2 is a flowchart illustrating a print job process.

FIG. 3 is an explanatory diagram illustrating font information in a first format.

FIG. 4 is an explanatory diagram illustrating font information in a second format.

FIG. 5 is a flowchart illustrating a font registration process.

FIG. 6 is a flowchart illustrating an intermediate character data generation process.

FIG. 7 is a flowchart illustrating a print job process.

FIG. 8 is a flowchart illustrating a font registration process.

### DESCRIPTION

Below, a printer according to a first embodiment will be described in detail while referring to the accompanying drawings. This embodiment discloses a printer capable of printing based on print data described in a page description language (PDL).

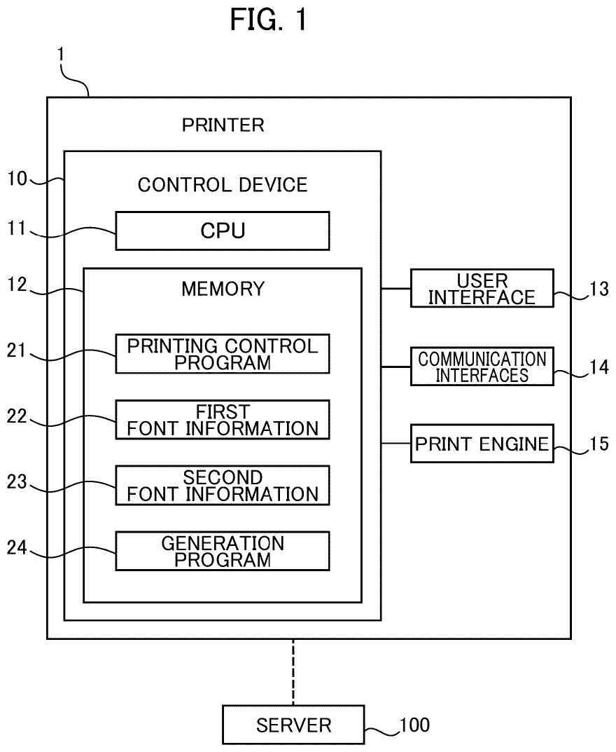

FIG. 1 shows a printer 1 according to the present embodiment. The printer 1 is provided with a control device 10 that includes a CPU 11 and a memory 12. The printer 1 is also provided with a user interface (also abbreviated as “user IF”) 13, a communication interface (also abbreviated as “communication IF”) 14, and a print engine 15. The user interface 13, the communication interface 14, and the print engine 15 are all electrically connected to the control device 10. Note that the control device 10 in FIG. 1 is a collective term that covers all hardware and software used for controlling the printer 1 and is not actually limited to representing a single piece of hardware present in the printer 1. The CPU 11 is an example of a controller. The control device 10 is another example of the controller.

The CPU 11 executes various processes, according to programs read from the memory 12 or on the basis of user operations. The memory 12 stores various programs and various data. The memory 12 is used as a work area for executing various processes. The memory 12 may include a buffer provided by the CPU 11.

An example of the memory 12 is the ROM, RAM, and HDD provided in the printer 1, and any storage medium from which the CPU 11 can read data and to which the CPU 11 can write data. An external memory, such as a USB memory or an HDD, connected to the printer 1 via the communication IF 14 is an example of the memory 12. Or, an external memory, such as a USB memory or an HDD, provided in an external device that is connected to the printer via the communication IF 14 is an example of the memory 12.

The memory 12 stores, a printing control program 21, first font information 22, second font information 23, and a generation program 24. Each of the first and second font information 22 and 23 may be or may not be stored on the printer 1 when the printer 1 is shipped from a factory. The details of each program and each data will be described later.

The user interface 13 includes hardware that displays screens for reporting information to the user, and hardware that receives operations performed by the user. The user interface 13 may include a touchscreen or a combination of a display and operation buttons.

The communication interface 14 includes hardware for communicating with an external device. The communication standard employed by the communication interface 14 may be Ethernet, Wi-Fi (U.S. trademark of Wi-Fi Alliance CORPORATION), Universal Serial Bus (USB), or the like. Alternatively, the printer 1 may be provided with a plurality of communication interfaces 14 supporting a plurality of communication standards. The communication interface 14 may be a network interface.

The print engine 15 includes a device capable of printing based on image data according to the electrophotographic or inkjet method, for example. The print engine 15 may be provided with colorants of a plurality of colors to be able to execute color printing or may be provided with colorant in a single color for monochrome printing.

The printer 1 can communicate with a server 100 via the communication interface 14, as illustrated in the example of FIG. 1. The server 100 may be an external device that stores information on fonts. In accordance with user instructions, the printer 1 can receive a file containing font information from the server 100 and store this file in the memory 12. By connecting USB memory storing font information to the printer 1, for example, the user can make this font information available to the printer 1.

Operations of the printer 1 according to the first embodiment will be described. Following processes are basically processes performed by the CPU 11 according to programs. The processes performed by the CPU 11 include processes that control hardware through an Application Programming Interface (API) provided in an Operating System (OS) of the printer 1. In the present disclosure, the description of the OS may be omitted when the operations of each program performed using the OS are described. Note that the term “acquire” in this specification is used as a concept that does not necessarily require a request. Further, “data” may be treated as the same data even when the format (such as a text format, binary format, or flag format) is modified, provided that content of the data is essentially the same.

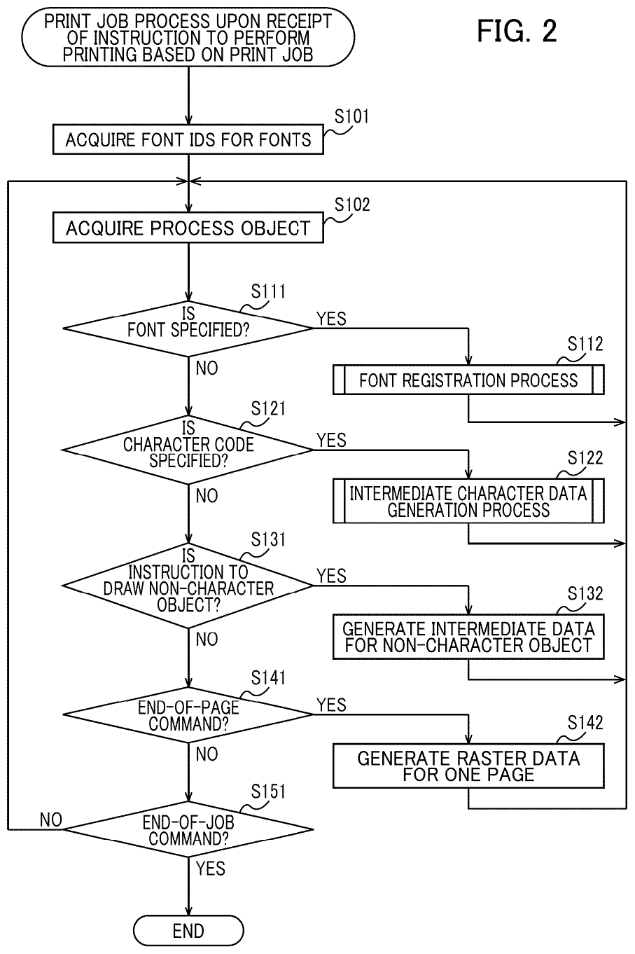

The printer 1 can acquire a print job and execute printing based on the acquired print job. Steps in a print job process based on the acquired print job will be described while referring to the flowchart shown in FIG. 2. The print process is performed by the CPU 11 of the printer 1 according to the print control program 21. The printer 1 may acquire the print job by receiving the print job from an external device via the communication IF 14 or by reading the print job from the USB memory mounted on the communication IF 14.

A print job includes both page description language (PDL) data and printer job language (PJL) data. The PDL data is data described in a page description language that represents the image to be printed. The PJL data represents various printing-related parameters. A print job may contain PDL data of one of various formats, including the Portable Document Format (PDF) or the Printer Command Language 5 (PCL 5) format. The PCL 5 format is a file format developed by Hewlett Packard (U.S. registered trademark of HP HEWLETT PACKARD GROUP LLC). The printer 1 can identify the type of the PDL data based on the PJL data, for example. The PDL data in the PDF format is an example of a first type print data. The PDL data in the PCL 5 format is an example of a second type print data.

FIG. 2 shows the print job process executed on the printer 1 when the printer 1 receives an instruction to perform printing based on a print job containing PDL data in the PCL 5 format. A description of print job processes for print jobs containing PDL data in formats other than PCL 5 is omitted in this specification.

In S101 of the print job process, the CPU 11 acquires font IDs for identifying fonts. A font ID is information, such as a numerical value, associated with an individual font. The font ID may also be a character string. The font ID may be for identifying a font or a typeface of the font, such as, Times New Roman, Helvetica, Arial, Mincho, and Gothic. The CPU 11 may configure font IDs for uniquely identifying typefaces of the fonts. The font ID is an example of first identification information.

Specifically, in S101 the CPU 11 acquires font IDs associated with information of all fonts contained in font information (the first font information 22 and second font information 23 in this example) stored in the memory 12. The CPU 11 may also acquire font IDs associated with font information stored in USB memory when USB memory storing the font information is connected to the printer 1.

The printer 1 can store information for fonts as font files, for example. Here, each font file may include data defining outlines of characters as glyph data for a corresponding typeface. Each of the first font information 22 and second font information 23 may include a plurality of font files. Each font file may or may not be a file managed by the file system but is information containing a plurality of sets of glyph data representing the shapes of characters for a single font. The glyph data is an example of font data.

A font ID may be included in the font file or may be associated with the font file but stored separately therefrom. When the printer 1 has downloaded a font file from an external device, for example, the printer 1 may generate a font ID and store the generated font ID in association with the downloaded font file. The CPU 11 may generate the font ID for uniquely identifying the font or a typeface of the font.

The first font information 22 includes font files storing glyph data of a first format, which is supported by PDL data in the PDF format. Font files containing glyph data in the first format include font files of TrueType fonts, OpenType fonts, and PostScript fonts. The printer 1 cannot use font files in the first font information 22 as is when printing print jobs containing PDL data of the PCL 5 format. That is, PDL data in the PDF format supports font files in the first format whereas PDL data in the PCL 5 format does not supports font files in the first format but supports the font files in a second format described later. That is, font files in the first format are compatible with the PDL data in the PDF format whereas font files in the second format is compatible with PDL data in the PCL 5 format. The font file included in the first font information 22 is an example of a first font file.

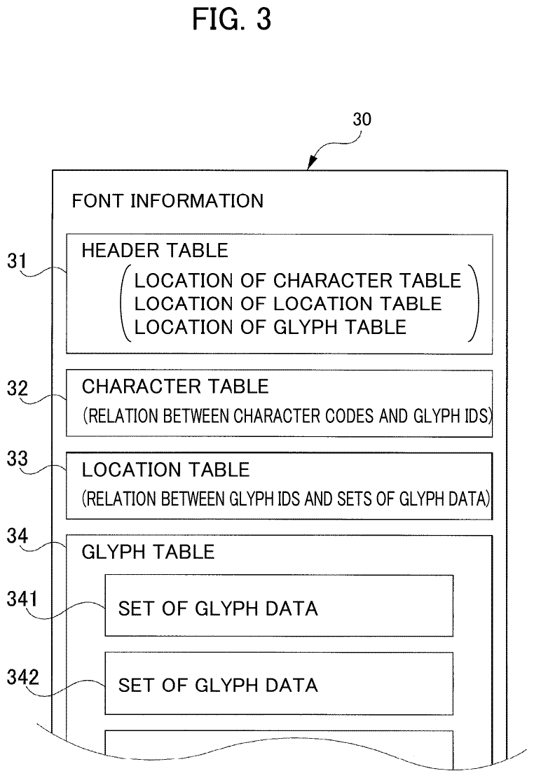

A font file of the True Type font format included in the first font information 22 has font information 30. As shown in the example of FIG. 3, the font information 30 is configured with a header table 31, a character table 32, a location table 33, and a glyph table 34. The font information 30 may further include information specifying the printing position and information specifying the character width for each character.

The header table 31 stores information including location information for the character table 32, location table 33, and glyph table 34. The character table 32 maps the character code of each character to a glyph ID for the same character. A character code is information identifying an individual character. The location table 33 maps each glyph ID to location information for a set of glyph data associated with that glyph ID. A glyph ID is identification information that identifies a set of glyph data for an individual character.

The glyph table 34 stores a plurality of sets of glyph data 341, 342, . . . . Each set of glyph data is information specifying the outline of the corresponding character and is assigned to a unique glyph ID.

The second font information 23 includes font files storing glyph data in a second format supported by PDL data in the PCL 5 format. The printer 1 can use font files included in the second font information 23 as is for printing a print job containing PDL data of the PCL 5 format. Hereinafter, the font of a font file supported by print data in the PCL 5 format will be referred to as a “PCL font”. The font file included in the second font information 23 is an example of a second font file.

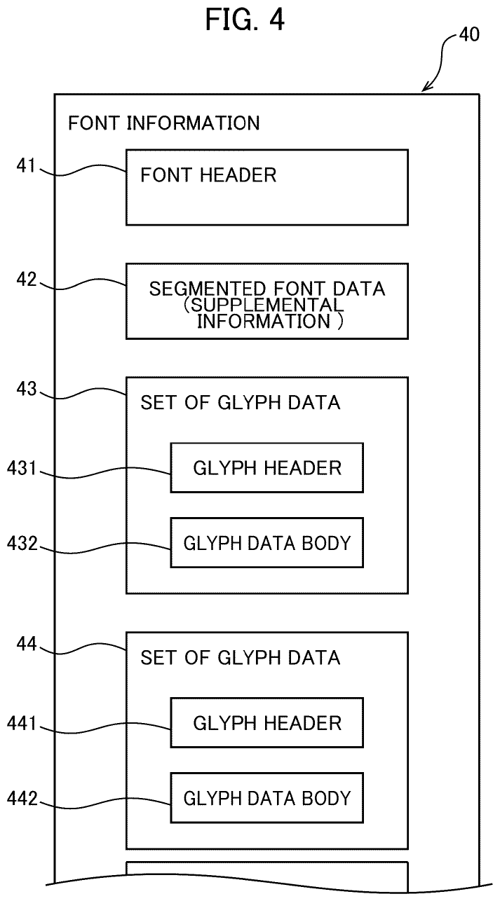

A font file included in the second font information 23 for a PCL font has font information 40. As shown in the example of FIG. 4, the font information 40 is configured with a font header 41, segmented font data 42, and a plurality of sets of glyph data 43, 44, . . . .

The font header 41 includes a font ID and stores overall information on the font. The segmented font data 42 stores supplemental information of the font information 40 for the PCL font, for example. The set of glyph data for each character includes a glyph header (431 or 441) and a glyph data body (432 or 442). The glyph header 431 (441) is information related to the set of glyph data 43 (44) that includes format information, size information, and a glyph ID, for example. A glyph data body 432 (442) is information indicating the outline of the character represented by the set of glyph data 43 (44) and corresponds to a set of glyph data included in the font information 30 (see FIG. 3), such as, the sets of glyph data 341, 342, . . . .

In other words, a set of glyph data contained in a font file of the first font information 22 (e.g., the glyph data 341 in FIG. 3) and a set of glyph data contained in a font file of the second font information 23 (e.g., the glyph data 43 in FIG. 4) have different formats. The printer 1 uses sets of glyph data of a format in accordance with a type of PDL data included in the print job in order to draw text (characters). That is, the format of sets of glyph data to be used when drawing text (characters) varies depending on the type of PDL data included in the print job.

Returning to the description of the print job process in FIG. 2, in S101 the CPU 11 can acquire font IDs for fonts in the second font information 23. Specifically, the CPU 11 reads a font ID from the font headers 41 in each set of font information 40 (see FIG. 4) included in a corresponding one of font files in the second font information 23. The CPU 11 also reads font IDs that are included in the first font information 22 or associated with the font files included in the first font information 22. However, a font ID may not be associated with each set of font information 30 (see FIG. 3) included in the first font information 22. When a font ID is not associated with any font information stored in the memory 12 or in USB memory, in S101 the CPU 11 may set a font ID in association with each font that is currently associated with no font ID. In this case, the font ID may set so that the set font ID can identify a typeface and/or format of a font. In such a case, in S101 the CPU 11 may also acquire each font ID newly associated with the font.

In S102 the CPU 11 acquires a process object from the print data included in the print job. The process object is a unit of data that the CPU 11 performs a process indicated therein. For example, the process object is a command, a text object, a drawing object, or an image object. The print data can include a plurality of process objects. By repeatedly performing the process of S102, the CPU11 acquires continuously the plurality of process objects from the top of the print data. In S111 the CPU 11 determines whether the acquired process object includes a font ID selection command specifying a font of a character to be printed. A font ID selection command includes a font ID specifying the font to be used for printing. The process of S102 is an example of an acquisition process.

When the CPU 11 determines that the acquired process object includes a font ID selection command (S111: YES), in S112 the CPU 11 executes a font registration process. The font ID included in the font ID selection command in the process object acquired in S102 is an example of second identification information.

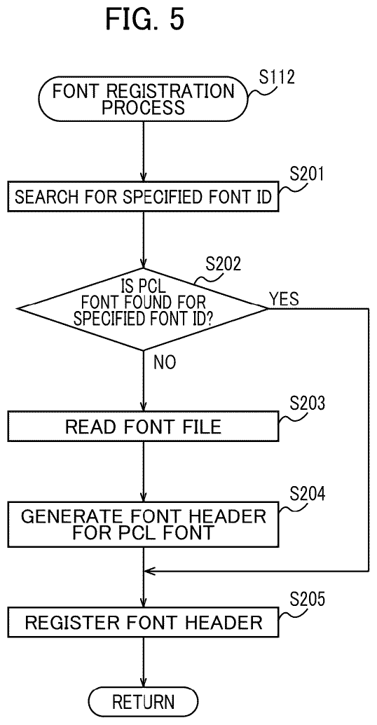

Steps in the font registration process will be described with reference to the flowchart in FIG. 5. In S201 of the font registration process, the CPU 11 searches the font IDs of all font files for the font ID matching the font ID specified in the font ID selection command. Specifically, when the CPU 11 finds the font ID matching the font ID specified in the font ID selection command from among the font IDs acquired in S101 of the print job process, the CPU 11 identifies the font of the font ID as the font specified in the print data. The process of S201 is an example of a font specification process.

In S202 the CPU 11 determines whether a font ID matching the font ID specified in the font ID selection command is found from among the font IDs acquired in S101. When such a font ID is found, the CPU 11 specifies a font of the found font ID and further determine whether the specified font of the found font ID is a PCL font. When there is a plurality of fonts (font files) of the found font ID, the CPU determines whether there is a PCL font among the plurality of fonts (font files).

When the specified font is not a PCL (or, there is no PCL font whose font ID matches the font ID specified in the font ID selection command) (S202: NO), in S203 the CPU 11 reads the font file for the font identified in S201 into a volatile area of the memory 12. Note that when the CPU 11 could not find a font ID in S201 or could not read a font file in S203, the CPU 11 may determine that an error has occurred or may substitute another font stored on the printer 1 for the specified font. This another font may be an alternate font described later.

In other words, in S202 the CPU 11 determines whether a font file of the PCL font satisfying a prescribed requirement is stored in the memory 12. Here, the prescribed requirement is a requirement for a font file (or a set of glyph data in that font file) to be used for a character designated in the print data to be printed, and more specifically the requirement is to require the font (or typeface) specified in the print data for the character. Put differently, in S202 the CPU 11 determines whether the set of glyph data of the PCL font classified into the font (typeface) specified in the print data is stored in the memory for the character designated in the print data.

In S204 the CPU 11 generates a font header for a PCL font based on header information in the font file read in S203. For example, the CPU 11 generates a font header having the same structure as the font header 41 contained in the font information 40 shown in FIG. 4. The generated font header may not include a font ID at this stage. Or, the font header may include a font ID. When the font header includes a font ID, the font ID included in the font header may be or may not be the same as the font ID in the font ID selection command. When the font ID included in the font header is different from the font ID specified in the font ID selection command, the font ID included in the font header may include information or a value that is related to the font ID specified in the font ID selection command so that the font header is in association with the font ID specified in the font ID selection command. The font ID may represent a typeface and format (PCL font) of the font. The font ID included in the font header may have the font ID specified in the font ID selection command and additional information (values or characters) specifying a format of the font. That is, the font ID included in the font header may have the font ID specifying a typeface of the font and information (values or character) specifying a format of the font. The font header generated in S204 may include information for mapping character codes to sets of glyph data (glyph IDs for example) but includes no set of glyph data for any character.

After completing the process in S204 or when determining in S202 that a PCL font is present (S202: YES), in S205 the CPU 11 registers the font header internally. Here, the CPU 11 registers the font header generated in S204 or the font header for the identified PCL font. After completing the process in S205, the CPU 11 ends the font registration process and returns to the print job process.

Returning to the description of the print job process in FIG. 2, after completing the font registration process of S112 the CPU 11 returns to S102 to acquire a next process object from the print data. When the CPU 11 determines in S111 that the newly acquired process object includes no font ID selection command (S111: NO), in S121 the CPU 11 determines whether the acquired process object includes a character code specifying a character to be printed.

When the CPU 11 determines that the acquired process object includes a character code (S121: YES), in S122 the CPU 11 executes an intermediate character data generation process for the character to be printed. When in S102 the CPU 11 acquires the process object specifying the font, and thereafter in the subsequently-executed S102 the CPU 11 acquires another process object specifying the character code, the CPU 11 performs the intermediate character data generation process to generate intermediate data for the character of that character code using the font of the font header registered in the process of S205 that has been performed for the previously-acquired print process. The process of S102 to acquire the character code of the character to be printed is an example of a character acquisition process.

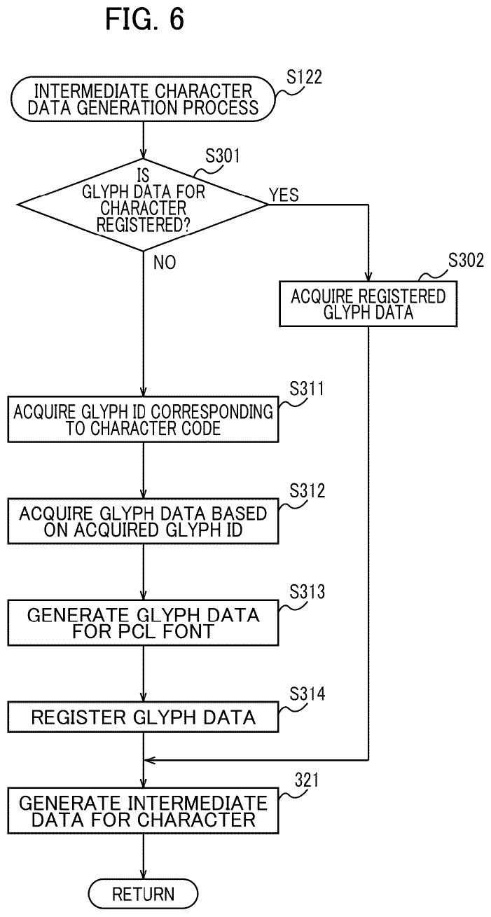

Here, steps in the intermediate character data generation process will be described with reference to the flowchart in FIG. 6. In S301 of FIG. 6, the CPU 11 determines whether the font header is registered and whether a set of glyph data for the character to be printed is registered in association with the registered font header. The CPU 11 make YES determination when the font header and the set of glyph data for the character are included in a font file or when the font header and the set of glyph data for the character are separately stored in the memory 12. Here, the font header is registered in S205 of the font registration process described earlier with reference to FIG. 5.

When no font header has been registered at the start of the intermediate character data generation process, the CPU 11 may determine that an error has occurred or may use an alternate font. For example, when a font file for a PCL font is stored in the memory 12 as an alternate font, the CPU 11 may read the font file stored in the memory 12 for this PCL font and register a font header in the font file.

When the CPU 11 determines that a set of glyph data has been registered for the character to be printed (S301: YES), in S302 the CPU 11 acquires this registered set of glyph data to be used for rasterization. The set of glyph data acquired in S302 is glyph data for a PCL font in a format supported by (or compatible with) print data in the PCL 5 format. The process of S302 is an example of a font data identification process.

When a font of the font ID found in S201 in the font registration process (see FIG. 5) is a PCL font, for example, the CPU 11 can acquire a set of glyph data for a character on the basis of the font header registered in S205 of the font registration process. When the font of the font ID found in S201 is a PCL font but there is no set of glyph data corresponding to the character code, the CPU 11 may generate intermediate data of a blank character, for example.

On the other hand, when a font of the found font ID in S201 of the font registration process is not a PCL font, there is a case that a set of glyph data has not been registered yet for a certain character, even though a font header has been registered. When the CPU 11 determines that no set of glyph data has not been registered for the character to be printed (S301: NO), in S311 the CPU 11 acquires a glyph ID corresponding to the character code from a font file that is not a PCL font and has been read in S203 of the font registration process. The glyph ID is information identifying a set of glyph data for an individual character and specifies the storage location of that set of glyph data.

In S312 the CPU 11 further acquires the set of glyph data for the character corresponding to the acquired glyph ID from the font file read in S203 in the font registration process. Because the identified font is not a PCL font, the set of glyph data acquired in S312 is not a set of glyph data for a PCL font.

In S313 the CPU 11 generates a set of glyph data for the PCL font on the basis of the set of glyph data acquired in S312. For example, the CPU 11 generates a set of glyph data having a PCL font structure by adding, as a glyph header, format information, size information, a glyph ID, and the like for the character to the set of glyph data in the TrueType font format acquired in S312. In other words, in S313 the CPU 11 generates a set of glyph data including a glyph header and a glyph data body as shown in FIG. 4. The process of S313 is an example of a generation process.

The CPU 11 executes the process of S313 in accordance with the generation program 24. The generation program 24 may be included in the print control program 21 or may be called and executed from the print control program 21.

In S314 the CPU 11 then registers the set of glyph data generated for the single character in S313 in association with the registered font header. In other words, the CPU 11 stores the set of glyph data acquired in S313 as a set of glyph data corresponding to the character code of the character to be printed. In S314 the CPU 11 may generate mapping information for mapping the character code of the character to be printed to the corresponding glyph ID for which the set of glyph data is generated. The CPU 11 may generate a hash table to register this mapping information in the hash table. The CPU 11 may store in the memory 12 the hash table in association with the registered font header. When the memory 12 already stores the hash table in association with the registered font header, the CPU 11 may register the generated mapping information in the hash table in the memory 1 without newly generating a hash table. The process of S314 is an example of a character storing process.

By generating and registering the set of glyph data in this way, the CPU 11 can acquire this registered set of glyph data in S302 of subsequent intermediate character data generation processes. Further, when the registered set of glyph data is acquired in S302, the CPU 11 does not re-register the acquired set of glyph data. In other words, the CPU 11 does not need to generate or register the same set of glyph data when the same character is printed multiple times in one print job, thereby reducing wasteful processing.

After completing the process in S302 or S314, in S321 the CPU 11 generates intermediate data for the character to be printed using the acquired set of glyph data. When a plurality of sets of intermediate data for a plurality of characters is generated for the current page, the CPU 11 may integrate these sets of intermediate data for the plurality of characters into the current page worth of intermediate data. In this case, the CPU 11 may arrange the set of intermediate data currently generated in S313 at a proper position in the current page worth of intermediate data. The intermediate data may be raster data. Following the process in S321, the CPU 11 ends the intermediate character data generation process and returns to the print job process.

The font headers registered in S205 of the font registration process and the set(s) of glyph data registered in S314 of the intermediate character data generation process are stored in a volatile area of the memory 12. That is, none of the font header and the set(s) of glyph data is stored in a nonvolatile area of the memory 12. In other words, this information is not retained in the memory 12 after the current print job is completed.

Returning to the description of the print job process in FIG. 2, following the intermediate character data generation process of S122, the CPU 11 returns to S102 and acquires a next process object. When the newly acquired process object includes no font ID selection command (S111: NO) and determines in S121 that the acquired process object include no character code specifying a character to be printed (S121: NO), in S131 the CPU 11 determines whether the acquired process object includes a drawing object specifying an instruction to draw a non-character object.

When the CPU 11 determines that the acquired process object includes a drawing object specifying the instruction to draw a non-character object (S131: YES), in S132 the CPU 11 generates and arranges intermediate data for the non-character object. The details of the process of generating intermediate data for non-character objects are omitted in this description.

When the CPU 11 determines that the acquired process object includes no drawing object specifying the instruction to draw a non-character object (S131: NO), in S141 the CPU 11 determines whether the acquired process object includes an end-of-page command indicating the end of the current page. When the acquired process object includes the end-of-page command (S141: YES), the CPU 11 generates raster data for one page on the basis of the generated intermediate data. In S141 the CPU 11 may control the print engine 15 to perform printing based on the generated raster data. The process of S142 is an example of a drawing process.

The print engine 15 of the printer 1 can perform printing for one page on the basis of the generated raster data. This process produces printed matter containing text (characters) drawn in fonts specified in font ID selection commands.

When the CPU 11 determines that the acquired process object includes no end-of-page command indicating the end of the current page (S141: NO), in S151 the CPU 11 determines whether the acquired process object includes an end-of-job command. When the acquired process object includes no end-of-job command (S151: NO), the CPU 11 returns to S102 and acquires a next print object for a next page. Once the CPU 11 determines in S151 that an end-of-job command was acquired (S151: YES), the CPU 11 ends the print job process.

As described above, when performing printing based on print data in the PCL 5 format, the printer 1 of the first embodiment can generate a set of glyph data of a PCL font on the basis of a set of glyph data in the first font information 22 stored in the memory 12 in order to draw text (a character) using this font. Therefore, when font data in the TrueType font format is stored in the memory 12, for example, the printer 1 can use the font data stored in the memory 12 to perform printing based on both print data in the PDF format and print data in the PCL 5 format.

Thus, by simply downloading font files containing font data in the True Type font format, for example, users can use the downloaded font files for printing, irrespective of the type of print data. Accordingly, users do not need to prepare font files in a plurality of formats for the same font (the same typeface), nor do users need to concern themselves with the type of print data.

Next, a printer according to a second embodiment of the present invention will be described in detail while referring to the accompanying drawings. Unlike the printer 1 of the first embodiment that registers only a font header when the font specified in the print job is not a PCL font, the printer 1 according to this embodiment generates and registers font information for a PCL font that contains not only a font header but also a set of glyph data for each character. In the following description, parts and steps identical to those described in the first embodiment will be designated with the same part numbers and step numbers to avoid duplicating description.

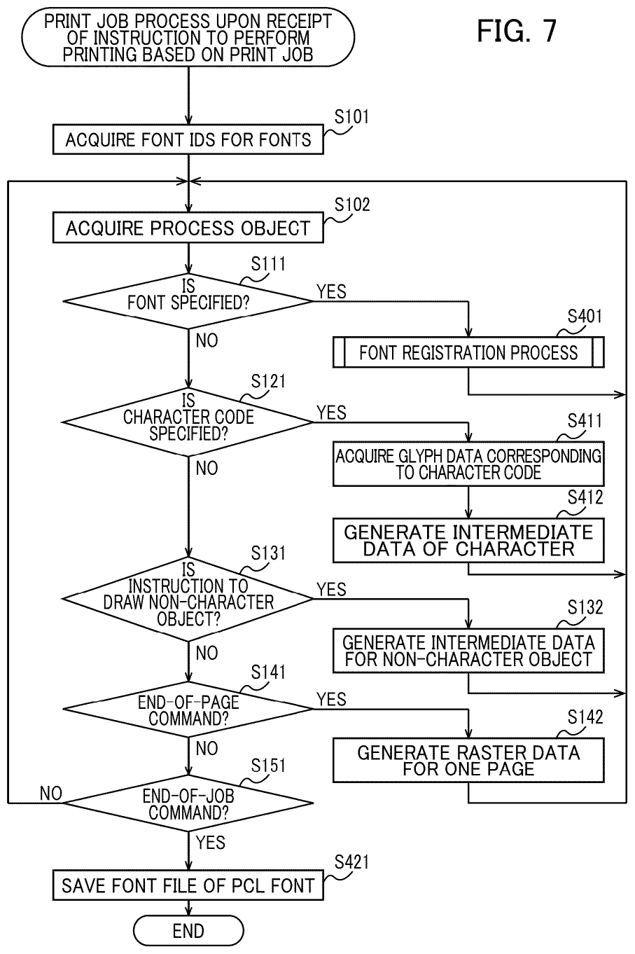

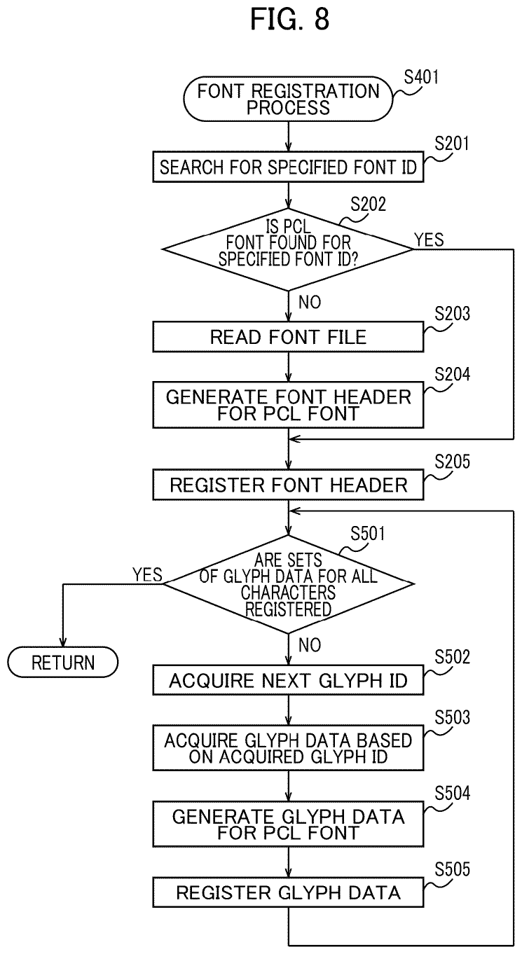

Steps in a print job process executed on the printer 1 according to the second embodiment will be described with reference to the flowchart in FIG. 7. When the CPU 11 of the printer 1 determines that a font ID selection command specifying a font is obtained in the second embodiment (S111: YES), in S401 the CPU 11 executes a font registration process shown in FIG. 8 in place of the font registration process shown in FIG. 5.

Here, steps in the font registration process executed on the printer 1 of the second embodiment will be described with reference to the flowchart in FIG. 8. In S201 of this font registration process, the CPU 11 searches for the font ID specified in the font ID selection command. In S202 the CPU 11 determines whether a font ID matching the font ID specified in the font ID selection command is found from among the font IDs acquired in S101. When such a font ID is found, the CPU 11 determines whether a font associated with the found font ID is a PCL font.

When the CPU 11 determines that the font associated with the found font ID is not a PCL font (S202: NO), in S203 the CPU 11 reads the font file for the font associated with the found font ID. In S204 the CPU 11 generates a font header for a PCL font on the basis of the font file read in S203. Following the process in S204 or when determining in S202 that a PCL font is present (S202: YES), in S205 the CPU 11 registers the font header internally.

In S501 the CPU 11 determines whether sets of glyph data for all characters have been registered in association with the font header registered in S205. When a font identified in S201 is a PCL font, sets of glyph data for all characters are already registered in association with the font header registered in S205. Thus, when the CPU 11 determines that the sets of glyph data for all characters has been registered (S501: YES), the CPU 11 ends the font registration process and returns to the print job process of FIG. 7.

However, when the identified font is not a PCL font, the CPU 11 has registered only the font header in S205 and has registered no sets of glyph data for the characters. Thus, while the CPU 11 determines that there is at least one unregistered set of glyph data for a PCL font for a character of all the characters defined in the font read in S203 (S501: NO), the CPU 11 generates a set of glyph data for a PCL font on the basis of the set of glyph data included in the font file read in S203 for an unregistered character so that the sets of glyph data for the PCL font can be generated for all the character. Here, the unregistered character is a character for which a set of glyph data for a PCL font is not registered.

Specifically, in S502 the CPU 11 acquires the glyph ID of a character that has not yet been registered from the font file read in S203. In S503 the CPU 11 acquires a set of glyph data for the character associated with the acquired glyph ID from the font file read in S203. In S504 the CPU 11 generates a set of glyph data for a PCL font on the basis of the glyph data obtained in S503. In S505 the CPU 11 registers the set of glyph data generated in S504. In a manner similar to S314, in S505 the CPU 11 may generate mapping information for mapping the character code of the character to be printed to the corresponding glyph ID for which the set of glyph data is generated. Further, the CPU 11 may register this mapping information in a hash table. The process in steps S503-S505 is similar to the process in steps S312-S314 of the intermediate character data generation process described in the first embodiment (see FIG. 6).

After completing the process in S505, the CPU 11 returns to S501 and determines whether the sets of glyph data for the PCL font have been registered for all the target characters. Here, the target characters are characters of all the sets of glyph data contained in the font file read in S203. When there remains an unregistered set of glyph data (S501: NO), the CPU 11 repeats the process in S502-S505.

Once all the sets of glyph data have been registered (S501: YES), the CPU 11 ends the font registration process and returns to the print job process in FIG. 7. Note that the font header and each set of glyph data registered in the font registration process is stored in a volatile area of the memory 12.

Returning to the description of the print job process in FIG. 7, after completing the font registration process of S401 the CPU 11 returns to S102 to acquire a next process object data. When the CPU 11 determines in S121 that the acquired process object includes a character code (S121: YES), in S411 the CPU 11 acquires a set of glyph data corresponding to the character code in the acquired process object from the sets of glyph data registered in the font registration process. When the hash table is generated in S505, the CPU 11 may refer to the hash table to specify and acquire the set of glyph data corresponding to the character code. In S412 the CPU 11 uses the acquired set of glyph data to generate intermediate data of the character. When a set of glyph data corresponding to the character code could not be found, the CPU 11 may generate intermediate data of a blank character, for example.

When the CPU 11 determines in S131 that the acquired print data is a drawing object for an object other than a character (S131: YES), in S132 the CPU 11 generates intermediate data based on the drawing object.

When the CPU 11 determines in S141 that the acquired process objects includes an end of page command (S141: YES), in S142 the CPU 11 generates one page worth of raster data based on the generated intermediate data. The print engine 15 prints the page based on this raster data.

When the CPU 11 determines in S151 that the acquired process object includes an end-of-job command (S151: YES), in S421 the CPU 11 saves the font header and sets of glyph data for the PCL font generated in the font registration process of S401 as a font file for the PCL font. The CPU 11 stores the font file for this PCL font in a nonvolatile area of the memory 12 or in USB memory connected to the printer 1. Following the process of S421, the CPU 11 ends the print job process. The process of S421 is an example of a saving process.

In S421 the CPU 11 generates a font ID and stores the font ID in association with the font file. The generated font ID may be the same as one of the font IDs of font files already stored or different from the font IDs of font files already stored. For example, the font ID stored in association with this font file may be the same font ID of the original font file read in S203 of the font registration process (see FIG. 8), i.e., the font file for a non-PCL font. Alternatively, the CPU 11 may store a font ID having the same font ID of the original font file and additional information (values or characters) specifying that the font is the same as the font in the original font file but is in a different format. That is, the CPU 11 may store a font ID including information indicating that a typeface of the font is the same as that of the original font file and information indicating that a format of the font is different from that of the original file.

As described above, the printer 1 according to the second embodiment generates a set of glyph data for a PCL font on the basis of the set of glyph data in the first font information 22, just as the printer 1 according to the first embodiment. Therefore, users can use downloaded font information, for example, without concerning themselves with the type of print data.

The printer 1 according to the second embodiment also generates the sets of glyph data for all characters and saves this glyph data as a font file. Hence, when the same font is specified in subsequent print jobs, for example, the printer 1 can read the saved font file from the memory 12 and use the sets of glyph data included therein. This arrangement can eliminate the time required to generate sets of glyph data in subsequent print job processes, leading to faster printing times. Further, the printer 1 according to the second embodiment uses a simpler algorithm for the process of generating sets of glyph data for all characters than the printer 1 of the first embodiment, which generates sets of glyph data only for the characters to be used in printing.

The printer 1 according to the first embodiment, on the other hand, does not save generated sets of glyph data in the memory 12 since sets of glyph data for all characters may not have been generated in the first embodiment. Accordingly, the printer 1 can avoid errors in subsequent print jobs by not saving the sets of glyph data as a font file. Further, by generating sets of glyph data only for characters required in printing, the printer 1 according to the first embodiment requires less processing load for generating the sets of glyph data than a printer 1 that generates sets of glyph data for all characters. This method is particularly effective for fonts having many character types, such as Japanese fonts.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, the printer 1 may not be a device having only the printing function and may be any device having a different function in addition to a printing function, such as a multifunction peripheral, a copying machine, and a facsimile device.

Distinguishing between the first font information 22 and second font information 23 is not essential. That is, it is sufficient for the printer 1 to store a font file for each font. Further, when sets of glyph data for all characters are generated in the print job process, a font file containing the generated sets of glyph data for all characters may be saved in the first embodiment, as well.

While sets of glyph data for characters to be printed in a print job is registered and reused in the same print job in the first embodiment, no set of glyph data may be reused. Specifically, steps S301 and S302 of FIG. 6 may be eliminated from the intermediate character data generation process described in the first embodiment. In this case, each time a character is specified as the character to be printed, the CPU 11 reads a set of glyph data for that character from the font information, such as font information in the TrueType font format. The CPU 11 may further generate and use a set of glyph data for a PCL font on the basis of the read set of glyph data. Steps S301 and S302 may be eliminated when the font of the subject is a font that has been determined as a font other than a PCL font in S201.

In the second embodiment, the printer 1 saves a font file for the generated PCL font in a nonvolatile area of the memory 12 after completing the print job process, but the printer 1 need not save the font file. Specifically, step S421 (FIG. 7) of the print job process according to the second embodiment may be eliminated. The printer 1 may also be configured to accept a user specification regarding whether or not to save the font file, and save the font file in accordance with the user specification.

The printer 1 may also be capable of executing both the process according to the first embodiment and the process according to the second embodiment. In this case, the printer 1 may perform the process according to the first embodiment when the number of characters in the font file is greater than a prescribed number and may perform the process according to the second embodiment when the number of characters is not greater than the prescribed number, for example. The printer 1 may also be able to receive a user specification regarding whether to execute the process according to the first embodiment or the process according to the second embodiment, and perform the process in accordance with the user specification.

The printer 1 can process not only print data in the PCL 5 format but also print data in the PDF format, for example. When processing print data in the PDF format, the printer 1 can draw text (character) using font files in the first font information 22 as is. The printer 1 may also be capable of using font files for PCL fonts when processing print data in the PDF format.

In any of the flowcharts disclosed in the embodiments, the plurality of processes that makes up any of a plurality of steps may be executed in parallel, or the order in which the processes are performed may be modified in any way that does not produce any inconsistencies in the processes.

The processes disclosed in the embodiments may be performed by a single CPU, a plurality of CPUs, hardware such as one or more application specific integrated circuits (ASICs) or any combination of these. The processes disclosed in the embodiments may be implemented through various manners, such as a recording medium storing program instructions for the processes, or a method defining the processes.

What is claimed is:

1. A printer comprising:
a memory;
a print engine; and
a controller configured to perform:
an acquisition process to acquire print data;
when the print data is of a second type different from a first type, a generation process to generate a new set of font data in the second format based on the set of font data in the first format stored in the memory, the first type of print data supporting a set of font data in a first format, the second type of print data supporting a set of font data in a second format different from the first format; and
when the generation process is performed, a drawing process to draw an image of a character designated in the print data using the new set of font data generated in the generation process.

2. The printer according to claim 1, wherein the controller is configured to further perform:
when the print data is of the second type, a font specification process to specify, as a specified font, a font designated in the print data,
wherein when a set of font data of the specified font is stored as the set of font data in the first format in the memory, the controller performs the generation process to generate the new set of font data in the second format based on the set of font data in the first format stored in the memory.

3. The printer according to claim 2, wherein the controller is configured to further perform:
when a set of font data of the specified font in the second format is stored in the memory, a second drawing process to draw the image of the character designated in the pint data using the set of font data of the specified font in the second format stored in the memory,
wherein when the set of font data of the specified font in the first format and the set of font data of the specified font in the second format are both stored in the memory, the controller performs the second drawing process without performing the generation process or the drawing process.

4. The printer according to claim 2, wherein the controller is configured to further perform:
acquiring first identification information from a first font file stored in the memory, the first font file including a plurality of sets of font data in the first format,
wherein when the first identification information matches second identification information included in a command in the print data, the controller performs the generation process to generate the new set of font data in the second format based on one of the plurality of sets of font data in the first format included in the first font file stored in the memory.

5. The printer according to claim 1, wherein the controller performs the generation process to generate the new set of font data based on the set of font data in the first format stored in the memory according to a set of generation program instructions stored in the memory.

6. The printer according to claim 1, wherein the generation process generates, for the character designated in the print data, the new set of font data based on the set of font data in the first format stored in the memory.

7. The printer according to claim 6, wherein the generation process includes:
specifying each character designated in the print data;
when no set of font data in the second format for the each character is stored in the memory, generating, for the each character, a set of font data in the second format based on a corresponding set of font data in the first format stored in the memory; and
storing the set of font data in the second format for the each character in the memory,
wherein when a set of font data in the second format for the each character is stored in the memory, the controller perform neither the generating for the each character nor the storing for the each character.

8. The printer according to claim 6, wherein the controller is configured to further perform:
controlling the print engine to perform printing based on the print data,
wherein after the printing based on the print data is completed, the controller stores no set of font data in the second format generated in the generation process in a nonvolatile area of the memory.

9. The printer according to claim 1, wherein when a first font file including a plurality of sets of font data in the first format is stored in the memory, the generation process generates a plurality of sets of font data in the second format each based on a corresponding one of the plurality of sets of font data included in the first font file.

10. The printer according to claim 9, wherein the controller is configured to further perform:
controlling the print engine to perform printing based on the print data; and
after the printing based on the print job is complete, a saving process to save the plurality of sets of font data in the second format generated in the generation process in a nonvolatile area of the memory.

11. The printer according to claim 10, wherein when a set of font data in the second format, which satisfies a requirement for a set of font data for the print data to be printed, is stored in the memory, the controller does not perform the generation process but reads the set of font data in the second format, which satisfies the requirement, from the memory to print the print data.

12. The printer according to claim 1, wherein the controller is configured to further perform:
storing, in the memory, a first font file downloaded from an external device, the first font file including a plurality of sets of font data in the first format; and
when the print data is of the first type, a second drawing process to draw an image of each character designated in the pint data using a corresponding one of the plurality of sets of font data included in the first font file stored in the memory,
wherein when the print data is of the second type, the controller performs both the generation process and the drawing process but does not perform the second drawing process.

13. The printer according to claim 12, wherein the controller is configured to further perform:
when the print data is of the second type, a specifying process to specify a requirement for a font file for the print data to be printed,
wherein when the first font file satisfying the requirement is stored in the memory, the controller performs: the generation process to generate the new set of font data in the second format based on a corresponding one of the plurality of sets of font data in the first font file satisfying the requirement; and the drawing process using the new set of font data generated in the generation process,
wherein the controller is configured to further perform:
when a second font file including a plurality of sets of font data in the second format is stored in the memory and the second font file satisfies the requirement, a second drawing process to draw the image of the character designated in the print data using a corresponding one of the plurality of sets of font data in the second format satisfying the requirement.

14. The printer according to claim 13, wherein the specifying process specifies the requirement on the basis of the character designated in the print data.

15. The printer according to claim 13, wherein when no second font file satisfying the requirement is stored in the memory but the first font file satisfying the requirement is stored in the memory, the controller performs: the generation process to generate the new set of font data based on a corresponding one of the plurality of sets of font data in the first font file satisfying the requirement; and the drawing process using the new set of font data generated in the generation process.
